(19) United States
(12) Patent Application Publication
(10) Pub. No.: US 2006/0188362 A1
(43) Pub. Date: Aug. 24, 2006

(54) Tilting drum dolly

(76) Inventors: Robert Andrew Link, Angola, IN (US); Deryl Thomas Webster, Angola, IN (US); Kenneth Schneider, Angola, IN (US)

Correspondence Address: BAKER & DANIELS LLP, 300 NORTH MERIDIAN STREET, SUITE 2700, INDIANAPOLIS, IN, 46204, US

(21) Appl. No.: 11/063,036

(22) Filed: Feb. 20, 2005

(51) Int. Cl. B65G 65/04

(52) U.S. Cl. 414/403

(57) ABSTRACT

The present invention includes a dolly assembly having a dolly for holding a container and a lever attached to the dolly, the lever having a first end, a second end and an elbow joining the first and second ends, wherein the second end is adapted to contact a bottom surface of the container and to tilt the container when pressure is applied to the first end.

### TECHNICAL BACKGROUND

The present invention relates generally to a dolly assembly and more specifically to a dolly assembly for use in emptying containers.

### BACKGROUND OF THE INVENTION

Dollies are typically used to move large and heavy objects such as appliances, boxes, containers full of miscellaneous content, and drums of liquid material. Over time, dolly assemblies providing other functional features have been developed. For example, one prior art dolly assembly enables a dolly user to adjust the height of one end of the dolly so that the dolly user can lift the end above a floor discontinuity and roll the dolly across the discontinuity. This dolly assembly includes a roller lever that is used to lift the end of the dolly, and the roller assembly may be foot actuated. Another existing dolly assembly includes a foot pedal used to disengage a container latched to the dolly.

### SUMMARY OF THE INVENTION

While dolly assemblies have been developed that improve upon both the transportation of objects on a dolly and the removal of objects from a dolly, a need still remains in the art for a dolly assembly that enables liquid to be more easily removed from a liquid-containing container. The present invention provides a lever, a dolly assembly and a method to fulfill this need.

In one embodiment of the present invention, a lever for tilting a container positioned on a dolly is provided, the lever including a first end, and a second end joined to the first end and adapted to contact the bottom surface of the container when pressure is applied to the first end.

In another embodiment of the present invention, a dolly assembly includes a dolly for holding a container having a bottom surface, and a lever attached to the dolly, the lever having a first end, a second end and an elbow joining the first and second ends, wherein the second end is adapted to contact the bottom surface of the container and to tilt the container when pressure is applied to the first end.

In still another embodiment, the present invention provides a method for tilting the container, the method comprising the steps of applying pressure to a first end of a lever attached to the dolly, the lever including a second end and an elbow joining the first and second ends, the second end adapted to contact the bottom surface of the container, and tilting the container as pressure is applied to the first end of the lever.

In yet another embodiment of the present invention, a lever is provided, the lever including actuating means for applying pressure to the lever, and tilting means for contacting the bottom surface of a container when pressure is applied to the actuating means, the tilting means joined to the actuating means.

### BRIEF DESCRIPTION OF THE DRAWINGS

The above mentioned and other features of this invention, and the manner of attaining them, will become more apparent and the invention itself will be better understood by reference to the following description of an embodiment of the invention taken in conjunction with the accompanying drawings, wherein:

FIG. 1 is a perspective view of one embodiment of the inventive dolly assembly supporting a container;

FIG. 2A is a perspective view of one embodiment of the dolly assembly shown in FIG. 1;

FIG. 2B is a perspective view of another embodiment of the dolly assembly shown in FIG. 1;

FIG. 3A is a partially fragmented, perspective view of one embodiment of the inventive lever of the dolly assembly shown in FIGS. 2A and 2B;

FIG. 3B is a partially fragmented, perspective view of the embodiment of the lever of FIG. 3A as shown in an upright position;

FIG. 4A is a partially fragmented, perspective view of one embodiment of the dolly assembly of the present invention before pressure is applied to the actuating portion of the lever and the container is tilted;

FIG. 4B is a partially fragmented, perspective view of the dolly assembly of FIG. 4A after pressure is applied to the actuating portion of the lever and the tilting portion of the lever tilts the container; and

FIG. 5 is a partially fragmented, perspective view of one embodiment of a dolly tilting mechanism.

Corresponding reference characters indicate corresponding parts throughout the several views. Although the drawings represent embodiments of the present invention, the drawings are not necessarily to scale and certain features may be exaggerated in order to better illustrate and explain the present invention.

### DESCRIPTION OF THE PRESENT INVENTION

The embodiments disclosed below are not intended to be exhaustive or limit the invention to the precise forms disclosed in the following detailed description. Rather, the embodiments are chosen and described so that others skilled in the art may utilize their teachings.

The use of the term “dolly” hereinafter refers to any platform used to hold and/or transport an object. It is conceived that the platform may be either stationary or mobile, may be any geometric shape (e.g., rectangular, square, oval or circular), and may or may not have openings in the bottom.

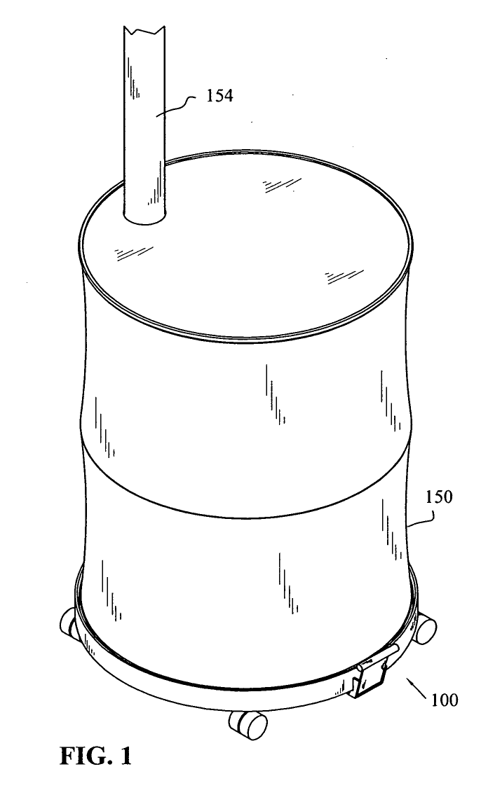

One embodiment of a dolly assembly is shown in FIG. 1. Dolly 100 is used to support and transport drum 150. Drum 150 may be filled with a liquid, and pumping mechanism 154 extending out from drum 150 may be used to remove any such liquid.

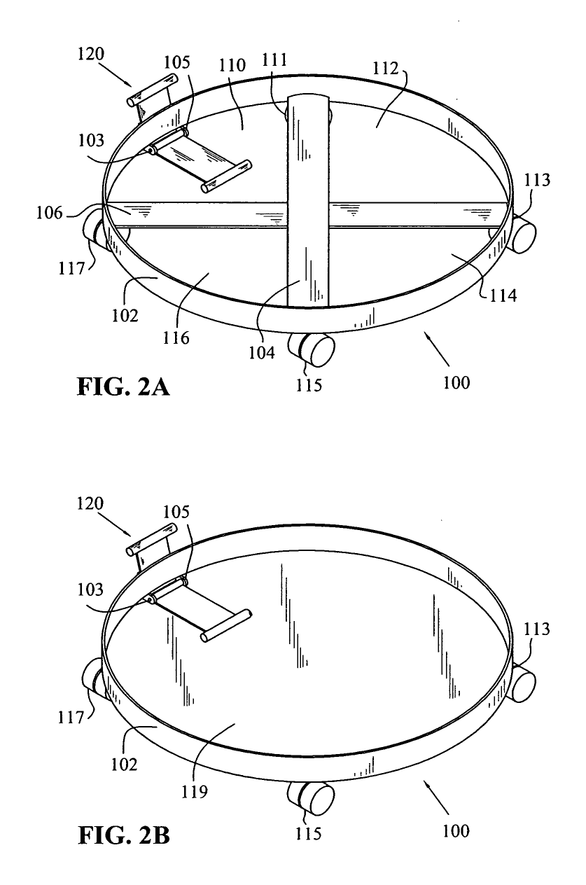

Shown in FIG. 2A, dolly 100 includes circular base 102, which has one or more brackets 103, 105 to secure lever 120 thereto. Brackets 103, 105 may be welded or otherwise attached to base 102, or in other embodiments of the present invention, base 102 and brackets 103, 105 may be formed from a single molded piece of material (e.g., steel).

Dolly 100 also may include cross-beams 104, 106 to support a container placed on dolly 100. Cross-beams 104, 106 form openings 110, 112, 114, 116 through which lever 120 may extend depending on where it is secured to base 102. In another embodiment of the dolly assembly, dolly base 102 may not include cross-beams 104, 106. In this embodiment, as shown in FIG. 2B, dolly base 102 includes solid bottom 119, and lever 120 pivots upward therefrom. Of course, bottom 119 may include drainage openings (not shown). In another embodiment, base 102 includes an inwardly projecting circumferential ledge (not shown) to support drum 150. Attached to the underside of dolly base 102 are casters 111, 113, 115, 117 on which dolly 100 may be rolled.

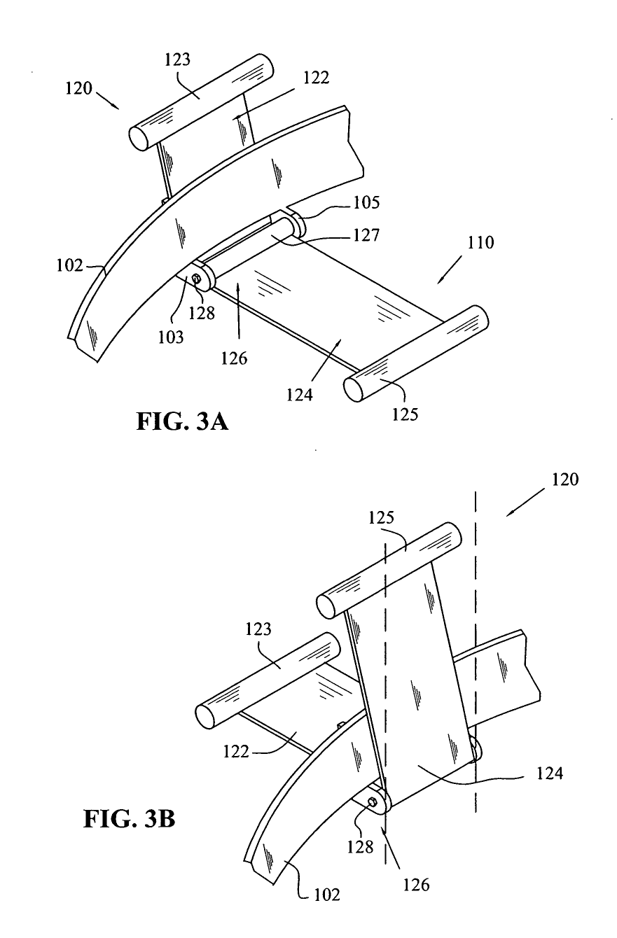

Referring now to FIG. 3A, lever 120 is shown in greater detail. Lever 120 includes a first end, or actuating portion 122, a second end, or tilting portion 124, and an elbow, or middle portion 126. Actuating portion 122 of lever 120 is positioned outside of base 102 and may include foothold 123. Foothold 123 may be attached to actuating portion 122 by known attachment methods, e.g., by welding or using epoxy resins. In other embodiments, actuating portion 122 and foothold 123 may be molded from the same material. In an exemplary embodiment of the present invention, actuating portion 122 is foot actuated, and foothold 123 is used to provide better traction for one using a foot to apply pressure to actuating portion 122.

Tilting portion 124 of lever 120 is positioned inside of base 102 and includes contacting portion 125. Similar to foothold 123, contacting portion 125 may be attached to tilting portion 124 by known attachment methods, and in other embodiments, tilting and contacting portions 124, 125 may be molded from the same material. Actuating and tilting portions 122, 124 of lever 120 come together at middle portion 126.

When pressure is applied to foothold 123 or actuating portion 122, lever 120 pivots upward. Shown in FIG. 3B, as lever 120 pivots upward, tilting portion 124 moves toward an upright position adjacent to the inside of base 102 and is maintained in the upright position by the weight of the object which tilting portion 124 is used to tilt. In an exemplary embodiment of the present invention, the weight of the tilted object maintains or “locks” lever 120 in the upright position when tilting portion 124 pivots past a vertical position (indicated by dashed lines in FIG. 3B) toward base 102. Lever 120 remains in the upright position until the tilted object is manually moved or tilted out of contact with lever 120 (after the object is emptied). When the weight off the tilted object is removed from lever 120, the weight of tilting portion 124 causes lever 120 to pivot back to its original position such that actuating portion 122 is adjacent to the outside of base 102 (FIG. 3A).

Referring back to FIG. 3A, in one embodiment of lever 120, middle portion 126 includes hinge member 127 containing a bore through which a pin (not shown) extends. The pin is sealed at both ends by cap members 128, 129 (cap member 129 not shown) on the outside of base brackets 103, 105, respectively, thereby fixedly attaching lever 120 to base 102 of dolly 100.

In another embodiment, hinge member 127 includes two pins that each extend into a corresponding opening in each of brackets 103, 105. Base brackets 103, 105 may also include openings that enable hinge member 127 to be lifted out of brackets 103, 105 so that lever 120 can be removed from dolly 100. In an exemplary embodiment of the present invention, middle portion 126 is angled and, consequently, lever 120 is substantially V-shaped. In other embodiments, lever 120 may be substantially planar such that middle portion 126 is substantially flat.

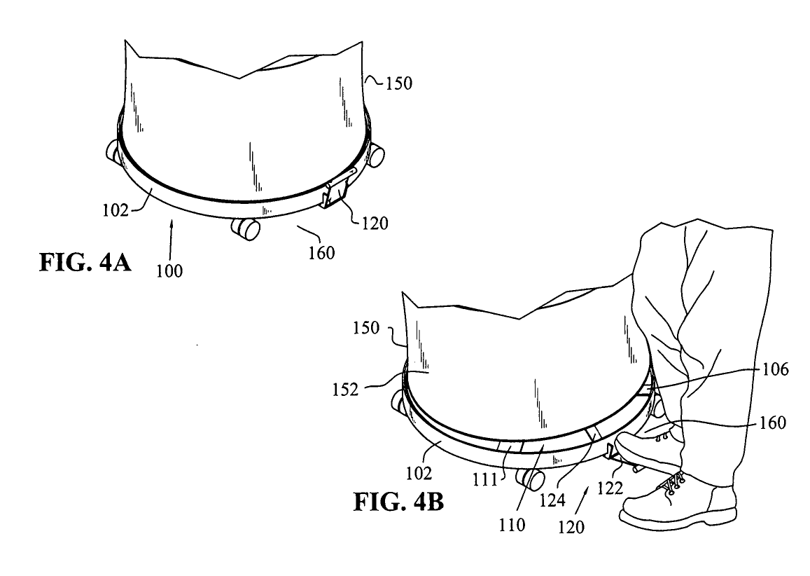

The workings of inventive lever 120 with dolly 100 is best described in accordance with the method of the present invention. Liquid-containing drum 150 is shown in FIG. 4A resting on dolly 100. Due to the size of drum 150, it is often difficult to completely empty drum 150 of the liquid it contains. It is contemplated that the method of the present invention may be used in such situations. Accordingly, and as illustrated in FIG. 4B, one may use their foot to apply pressure to actuating portion 122 of lever 120. As the foot presses actuating portion 122 towards ground plane 160, lever 120 pivots about hinge member 127 of lever 120 and tilting portion 124 extends upward through opening 110 in base 102 and contacts the bottom surface of drum 150. If base 102 includes solid bottom 119 (FIG. 2B), tilting portion 124 pivots upward from ground plane 160 (i.e., bottom 119) and contacts the bottom surface of drum 150. The more pressure that is applied to actuating portion 122, the higher tilting portion 124 tilts drum 150. When tilting portion 124 pivots past its vertical position, lever 120 is maintained in an upright position by the weight of drum 150. The tilting of drum 150 causes the liquid contained therein to gather in non-tilted side 152 of drum 150 where it may then be removed. After the liquid is removed, drum 150 is manually tilted out of engagement with tilting portion 124 and the weight of tilting portion 124 causes lever 120 to pivot back to its original position (shown in FIG. 4A).

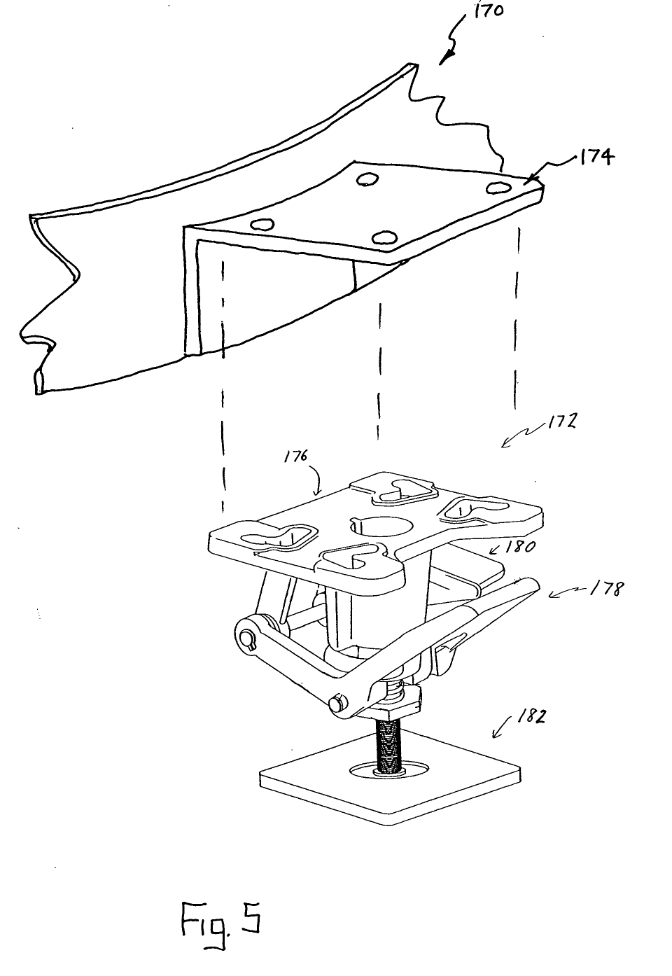

Another embodiment of the invention is shown in FIG. 5. In this embodiment, a lifting mechanism such as the castor braking mechanism described in U.S. patent application Ser. No. 10/961,321, which is expressly incorporated by reference herein, is added to a dolly. As shown in FIG. 5, dolly 170 includes a bracket 174 that supports tilting mechanism 172. Base 176 of tilting mechanism 170 couples to bracket 174. Base 176 includes first and second levers 178 and 180, and a floor engaging member 182. When lever 178 is depressed by a user, floor engaging member 182 is lowered to contact a floor surface. Lowering floor engaging member 182 lifts base 176 and bracket 174 which tilts dolly 170 allowing any fluid in a barrel positioned on dolly 170 to flow to the low side of the barrel to be received by a pump. Lever 180 is depressed to raise floor engaging member 182 which allows dolly 170 to be moved. In an alternative embodiment, only one lever is used to raise and lower floor engaging member 182. The operation of tilting mechanism 172 is described in more detail in U.S. patent application Ser. No. 10/961,321.

The embodiments described above generally include a lever mechanism or a lifting mechanism that is attached to a dolly to tilt the dolly and any container positioned on the dolly. As should be apparent, based on the foregoing, other suitable lever mechanisms or lifting mechanisms could be used to tilt the dolly in the manner described throughout this disclosure.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

We claim:

1. A lever for tilting a container positioned on a dolly and having a bottom surface, the lever comprising:
a first end; and
a second end joined to the first end and adapted to contact the bottom surface of the container when pressure is applied to the first end.

2. The lever of claim 1 wherein the first end is adapted to be foot actuated.

3. The lever of claim 1 further comprising a hinge member positioned proximate to an elbow joining the first and second ends.

4. The lever of claim 3 wherein the hinge member includes at least one pin about which the lever pivots when pressure is applied to the first end of the lever.

5. The lever of claim 3 wherein the hinge member is pivotally attached to the dolly.

6. The lever of claim 5 wherein the second end pivots from an original position to an upright position when pressure is applied to the first end.

7. The lever of claim 6 wherein the second end is maintained in the upright position under weight of the container.

8. The lever of claim 7 wherein the second end is configured to return to the original position when the weight of the container is removed.

9. A method for removing liquid in a container positioned on a dolly, the container having a bottom surface, the method comprising the steps of:
applying pressure to a first end of a lever attached to the dolly, the lever including a second end adapted to contact the bottom surface of the container; and
tilting the container as pressure is applied to the first end of the lever.

10. The method of claim 9 wherein the step of tilting includes a step of causing liquid to gather in one side of the container.

11. The method of claim 10 further comprising a step of removing the gathered liquid.

12. The method of claim 9 wherein the step of applying pressure includes a step of using one's foot to apply pressure to the first end of the lever.

13. The method of claim 9 wherein the lever includes a hinge member positioned proximate to an elbow joining the first and second ends, the hinge member including at least one pin.

14. The method of claim 13 wherein the tilting step includes a step of pivoting the hinge member about the at least one pin when pressure is applied to the first end.

15. The method of claim 14 wherein the pivoting step causes the second end to pivot into an upright position, the second end being maintained in the upright position by the container.

16. The method of claim 15 wherein the second end is configured to move out of the upright position when the bottom surface of the container is moved out of contact with the second end.

17. A dolly assembly comprising:
a dolly for holding a container having a bottom surface; and
a lever attached to the dolly, the lever having a first end and a second end, wherein the second end is adapted to contact the bottom surface of the container and to tilt the container when pressure is applied to the first end.

18. The dolly assembly of claim 17 wherein the first end is foot actuated.

19. The dolly assembly of claim 17 wherein the lever is pivotally attached to the dolly.

20. The dolly assembly of claim 17 wherein the lever includes a hinge member positioned proximate to an elbow of the lever that joins the first and second ends.

21. The dolly assembly of claim 20 wherein the hinge member includes at least one pin about which the lever pivots.

22. The dolly assembly of claim 17 wherein the dolly includes an outer side, the first end positioned adjacent to the outer side.

23. The dolly assembly of claim 17 further including at least one bracket attached to the dolly and adapted to hold the lever.

24. The dolly assembly of claim 17 wherein the dolly includes a plurality of crossbeams, the plurality of crossbeams defining an opening in the dolly.

25. The dolly assembly of claim 24 wherein the second end of the lever is positioned to pass through the opening in the dolly to contact the bottom surface of the container when pressure is applied to the first end.

26. A lever for tilting a container positioned on a dolly and having a bottom surface, comprising:
actuating means for applying pressure to the lever; and
tilting means for contacting the bottom surface of the container when pressure is applied to the actuating means, the tilting means joined to the actuating means.

27. The lever of claim 26 wherein the tilting means pivots in a first direction when pressure is applied to the actuating means.

28. The lever of claim 27 wherein the tilting means is maintained in an upright position when the tilting means pivots past a vertical position.

29. The lever of claim 27 wherein the tilting means is configured to pivot in a second direction when pressure is removed from the lever.

30. A dolly assembly comprising:
a dolly configured to hold a container having a bottom surface; and
a lifting mechanism coupled to the dolly including a floor engaging member and a lever configured to lower the floor engaging member, thereby causing the dolly to tilt.
